(19) United States
(12) Patent Application Publication
(10) Pub. No.: US 2012/0310854 A1
(43) Pub. Date: Dec. 6, 2012

(54) Physical Event Management During Asset Tracking

(76) Inventors: Nicholas D. Cova, Salt Lake City, UT (US); Nalini Subramaniyam, Union City, CA (US)

(21) Appl. No.: 13/569,884

(22) Filed: Aug. 8, 2012

Related U.S. Application Data
(62) Division of application No. 12/576,913, filed on Oct. 9, 2009.
(60) Provisional application No. 61/238,496, filed on Aug. 31, 2009.

(51) Int. Cl. G06Q 10/08

(52) U.S. Cl. 705/333

(57) ABSTRACT

Techniques for physical event management while tracking physical assets are disclosed. In one aspect, data identifying locations of interest in a journey of an asset is received. A position fix for the asset is received and a determination is made that the asset is within a location of interest. In another aspect, data identifying one or more milestones in a journey of the asset is received. An event notification is received from a tag coupled to the asset, and it is determined that there is a problem in the shipment of the asset. In yet another aspect, data identifying one or more actions that should be taken after events of interest in a journey of the asset is received. An event notification is received from a tag coupled to the asset, and it is determined that a particular action should be taken.

### CROSS-REFERENCE TO RELATED APPLICATIONS

This application claims the benefit under 35 U.S.C. §120 and is a divisional of U.S. patent application Ser. No. 12/576,913, titled “Physical Even Management During Asset Tracking,” filed Oct. 9, 2009, which claims the benefit under 35 U.S.C. §119(e) and is a nonprovisional of U.S. Patent Application No. 61/238,496, titled “Physical Event Management During Asset Tracking,” filed Aug. 31, 2009, which are both incorporated herein by reference.

### TECHNICAL FIELD

This subject matter is related generally to monitoring and tracking physical assets such as intermodal shipping containers.

### BACKGROUND

Various tracking services exist to track assets (e.g., intermodal shipping containers) as the assets journey from an origin location to a destination location. For example, some systems receive periodic updates on the location of assets, batch the updates, and then provide the batched updates to a user at a later time. However, the data received by these systems is often received well-after events in the journey of the asset have occurred. This delay makes it difficult for these systems to do real-time analysis for the shipment. In addition, the data is often received from multiple, independent systems. The use of multiple systems requires normalization, syntax mapping, and semantic understanding of the data, which creates further problems for real-time analysis.

Other systems use a wireless monitoring and tracking device coupled to the asset to receive real-time location updates. However, these tracking systems typically provide only raw tracking data without details of what the tracking data means in the overall context of the shipment or supply chain operations dependent on where the asset is during shipment. These systems fail to provide users real-time alerts that predict future problems with shipments. These systems also fail to identify when dependent processes should be initiated, and do not have the information required to initiate the dependent processes.

### SUMMARY

Techniques for physical event management while tracking physical assets, such as intermodal shipping containers, are disclosed. In one aspect, data identifying boundaries associated with locations of interest in a journey of an asset is received. When a position fix for the asset is received, a determination is made that the asset is within a particular location of interest, and a notification is generated. In another aspect, data identifying one or more milestones in a journey of the asset is received. When an event notification is received from a tag coupled to the asset, it is determined that there is a problem with the shipment, and a warning notification is generated. In yet another aspect, data identifying one or more actions that should be taken after milestones in a journey of the asset is received. When an event notification is received from a tag coupled to the asset, it is determined from the event notification and the received data that a particular action should be taken. A notification indicating that the particular action should be taken is generated.

Particular embodiments of the subject matter described in this specification can be implemented to realize one or more of the following advantages. Users can be warned of potential problems with the shipment of the asset before the problems occur. This can allow users to correct for the potential problems and thus prevent the problems from actually occurring. Users can be warned of actual problems with the shipment of the asset in time to correct for those problems. Dependent processes can be started at the appropriate time relative to an asset's journey, even without user input. The physical location of an asset can be given more useful meaning for a user, by being associated with a particular place of interest to the user. Users can be provided with information on the physical status of assets or notifications of problems with assets storing specific contents of interest to users.

### BRIEF DESCRIPTION OF THE DRAWINGS

FIG. 1 illustrates an example buyer, seller, and tag provider interacting in a shipping scenario.

FIG. 2 is a block diagram of an example tag system that associates a tag with an asset and monitors and tracks the asset using data received from the tag.

FIG. 3 illustrates an example journey of an asset from an origin location to a destination location.

FIG. 4 is a flow diagram of an example process for determining that an asset has entered or left a location of interest.

FIG. 5 is a flow diagram of an example process for determining that there is a problem in the shipment of the asset.

FIG. 6 is a flow diagram of an example process for determining that a dependent process should be triggered.

### DETAILED DESCRIPTION

### Overview of Asset Tracking

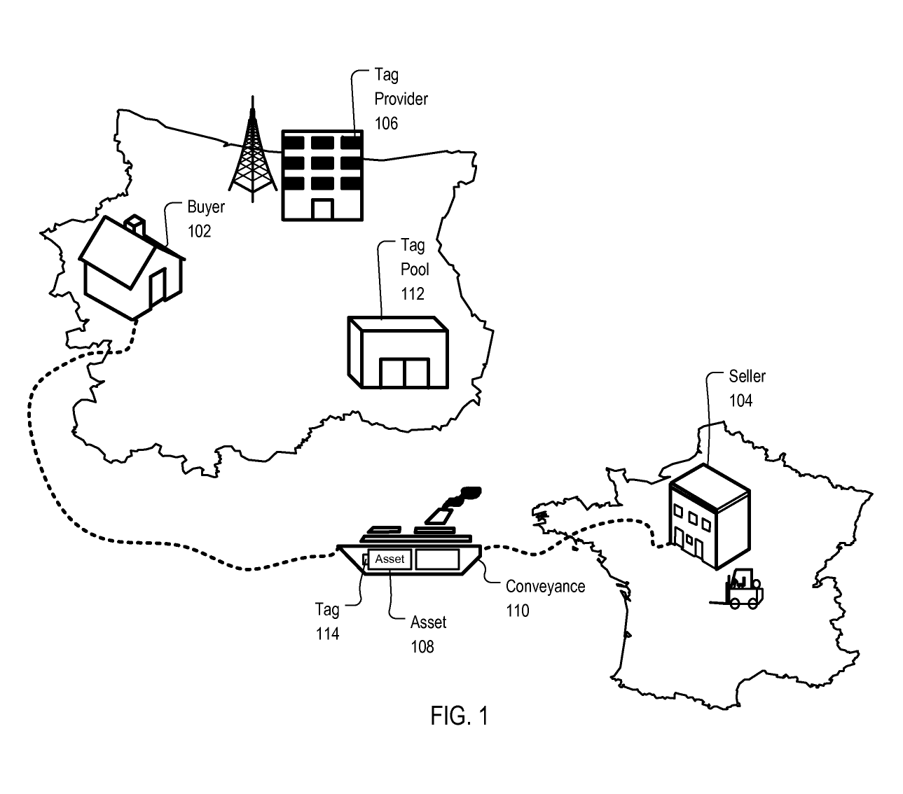

FIG. 1 illustrates an example buyer 102, seller 104, and tag provider 106 interacting in a shipping scenario. An example asset 108 is shipped from the seller 104 to the buyer 102 on example conveyance 110. In some implementations, the asset is an intermodal shipping container, however the asset can also be, for example, equipment, or other items capable of being monitored or tracked. Examples of conveyances include, but are not limited to, trucks, trains, ships, and airplanes. Examples of assets include, but are not limited to, containers such as dry-van containers, refrigerated containers, ISO tanks, trailers, box trucks, and unit load devices (ULDs).

In general, either the buyer 102 or the seller 104 sends a request to the tag provider 106 requesting tracking of the shipment of the asset 108. The tag provider 106 arranges for a selected tag 114 to be sent from tag pool 112 to the location from where the asset is being shipped (e.g., a warehouse of the seller 104). The tag pool 112 is a collection of available tags. Each tag in the tag pool 112 is a tracking device that can be used to track an asset. At the location where the tag is shipped (the “origin location”) the tag 114 can be affixed or coupled to the asset 108, thus securely sealing the asset 108. An example tag is the Savi Networks SN-LSE-01, which is a GPS-based Location+Security+Environmental tag. The tags do not have to use GPS, but can alternatively or additionally receive location information using various location technologies including, but not limited to: wireless networks, triangulation from cellular towers, or WiFi networks (e.g., Skyhook Wireless™ technology).

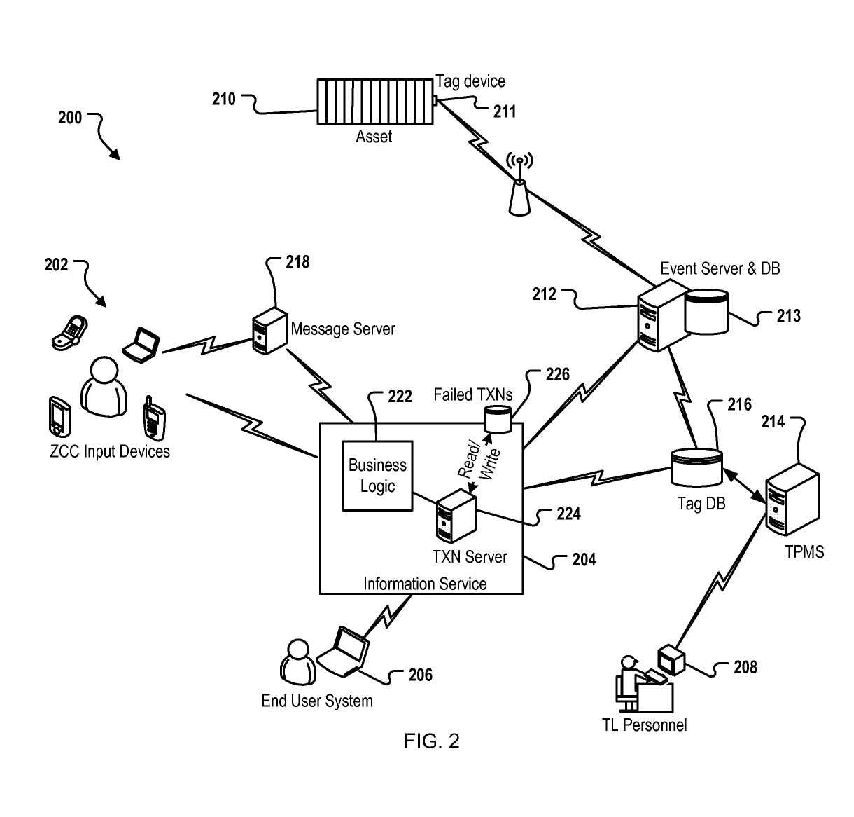

The selected tag 114 can be coupled to the asset 108 before the asset begins its journey or re-coupled to the asset 108 during the journey (e.g., after authorized custom inspections). During the journey, the tag 114 can be programmed to wake up periodically, initiate communication with the tag provider 106, and send event notifications to the tag provider 106. In general, each event notification can include an identification of the event (or event type), a location of the asset 108 when the event occurred, and additional details of the event such as a date and/or time when the event occurred, the status of the asset 108 before, during, or after the event, or details on the movement of the asset (e.g., accelerometer readings from the tag coupled to the asset). The event information can be stored by the tag provider 106, for example, in an event database. The tag 114 reports various events, including for example, security events, environmental events, process events, and tracking events. Security events can indicate that the asset 108 or tag 114 may have been tampered with. For example, the tag 114 can report when a vertical or horizontal bolt securing the tag 114 to the asset 108 is cut (indicating that the asset 108 was opened). Other types of tampers can also be detected (e.g., shock intrusion or light inside the asset that exceeds a threshold). Environmental events can indicate that one or more environmental variables (e.g., temperature, humidity, shock, acceleration) are beyond an acceptable range (e.g., a range specified by the user). Process events indicate that various procedural events in the journey of the asset have occurred. For example, process events can indicate that a tag 114 has been attached to the asset 108 or detached from the asset 108 (e.g., that the asset 108 is beginning or ending its tagged journey). Process events can also indicate other shipment events in the journey of the asset 108 (e.g., procedural events in the journey of the asset 108), including, but not limited to, that the asset 108 has been stuffed (e.g., filled with contents), that the asset 108 has been sealed, that the asset 108 has been flagged for customs inspection, that customs inspection of the asset 108 has begun, that customs inspection of the asset 108 has ended, that the asset 108 is in a shipping yard, that the asset has left a shipping yard, that the asset 108 has sailed, that the asset 108 has been berthed, and that the asset 108 has been unsealed. Tracking events are periodic reports of the tag's 114 location. For example, the tag 114 can send a report of its current location according to a schedule, for example, at fixed intervals of time, regardless of whether any other events have been issued. A tracking system (e.g., system 200 of FIG. 2) can process the tracking events to determine when an asset has entered or left a predefined area. For example, the system 200 can define geofences (e.g., a virtual perimeter) around important locations along the journey of the asset 108 (e.g., ports) and the tag 114 can report a process event when the tag 114 enters, leaves or persists in a geofence.

In some implementations, the tag provider 106 processes the various event notifications received from the tag 114 and provides notifications to the buyer 102 and/or the seller 104 and/or other parties. The notifications can be based, in part, on additional information received from the buyer 102 and/or the seller 104, for example, a description of the business of the buyer 102 and/or seller 104, a description of the contents of the asset 108, or a description of a transaction relevant to the contents of the asset 108. In some implementations, the tag provider 106 also provides the buyer 102 and/or the seller 104 and/or other parties with additional information about the journey of the asset, for example, warning notifications indicating problems with the shipment of the asset, or action notifications indicating that processes that are dependent to the shipment of the asset should be started. The notifications can identify the asset itself, as well as the contents of the asset.

In some implementations, the tag 114 also processes commands (e.g., Over-the-Air (OTA) commands) received from the tag provider 106 during a communication session between the tag 114 and servers operated by the tag provider 106.

### Example Tag System

FIG. 2 is a block diagram of an example tag system 200 that associates a tag with an asset and monitors and tracks the asset using data received from the tag. The system 200 commissions (associates) tags to assets, decommissions (disassociates) tags from assets, provides notifications of events (e.g., security, environmental, process, and tracking events), provides warning and action notifications, and can reset tag status remotely.

In some implementations, the system 200 can include one or more Zero Client Commissioning (ZCC) input devices 202, an information service 204, one or more end user systems 206, Tag Logistics Personnel (TL Personnel) 208, one or more assets 210, one or more tags 211 affixed or coupled to the one or more assets 210, an event server 212, an event database 213, a Tag Pool Management System (TPMS) 214, a tag database 216, a message server 218, a transaction (TXN) server 224, and a failed transaction database 226.

The ZCC input devices 202 are used to commission and decommission tags to assets. The ZCC input devices 202 can be any suitable communication device, including, but not limited to, mobile phones, land phones, email devices, and portable computers. The ZCC input devices 202 communicate with the information service 204 using a variety of communication modes, including but not limited to: Integrated Voice Response (IVR), Short Message Service (SMS), email, hand-held application, Web interface, and Electronic Data Interchange (EDI) or any other form of electronic message sharing. The ZCC input devices 202 can be operated by various actors having various roles in the supply chain, including but not limited to: dock workers, longshoreman, logistics service providers, freight forwarders, field agents, customs agents, and any other personnel involved in the tracking of an asset.

The information service 204 allows end user systems 206 to track the status of assets 210 in real-time. The transaction server 224 runs a tracking application that receives event location/status transaction messages (e.g., event notifications) or reports from the event server 212 and applies business logic 222 to the transactions for validating and maintaining associations between tag identifiers and asset identifiers. Successful transactions are posted against assets and tags. Failed transactions and reason codes are written to an exception queue in the failed transaction database 226.

The information service 204 can use a portal (not shown) to provide Web forms to end user systems 206 (e.g., a browser on a PC or mobile device). The Web forms can provide an input mechanism for a user to commission or decommission tags and can provide an output mechanism for users to receive real-time tracking and status information regarding assets and events. An example information service 204 is SaviTrak™ provided by Savi Networks, LLC (Mountain View, Calif.).

The tag 211 wakes up periodically to initiate communication with the event server 212 and to send event notifications to the event server 212. In general, each event notification includes an identification of the event (or event type), a location of the asset when the event occurred, and optionally additional details of the event such as the status of the asset before, during, or after the event. The event notification can also include an identification of the tag, or an identification of the asset to which the tag is coupled. The event information can be stored in the event database 213. The tag 211 reports various events, including for example, security events, environmental events, process events, tracking events, and location events, as described above with reference to FIG. 1.

The event server 212 periodically receives event notifications from the tag 211. The event server 212 also constructs and sends commands to the tag 211. Some notification management functions performed by the event server 212 include but are not limited to: checking incoming notifications for syntax errors and population of mandatory fields, checking the accuracy of location information in incoming notifications, sorting or sequencing notifications logically before forwarding the notifications to the information service 204, and constructing output transactions that comply with processing logic. The event server can receive and store position fixes (e.g., GPS position fixes). The position fixes can be received during sessions. For example, the tag 211 can receive position fixes every half-an-hour during a four hour window, and then upload the position fixes from the window during a session with the event server 212. The event server 212 can maintain the position fixes from the previous session (or previous sessions) and can also maintain the last good fix (e.g., the last accurate fix received from the tag, or a position fix whose location has been corrected by the system).

In some implementations, the TPMS 214 maintains an inventory of tags in the tag database 216. The TPMS 214 also maintains the association of the asset identifier (ID) and tag ID and the logical state or status of each tag, such as ‘In Use,’ ‘Available,’ ‘Begin Journey’, ‘End Journey’, etc. The TPMS 214 also maintains the allocation and availability of tags for logistics and pre-positioning purposes, and may track the health of tags stored in inventory.

In some implementations, the TPMS 214 allows TL personnel 208 to perform housekeeping functions, such as tag forecasts, ordering new tags, detecting lost tags, billing management, salvage and environmental disposal of failed tags, inventory tracking, customer help desk and financial accounting. The TPMS 214 allows TL personnel 208 to monitor the state of a tag 211 ‘in journey’, trouble shoot causes of failure in communicating with the event server 212, and locate lost tags. The TPMS 214 provides analytic tools to monitor tag network performance (e.g., GPS/GPRS coverage/roaming area for trade lanes).

The tag system 200 is one example infrastructure. Other infrastructures are also possible which contain more or fewer subsystems or components than shown in FIG. 2. For example, one or more of the servers or databases shown in FIG. 2 can be combined into a single server or database. As another example, tags can be associated with assets using dedicated handheld devices.

### Example Journey of an Asset

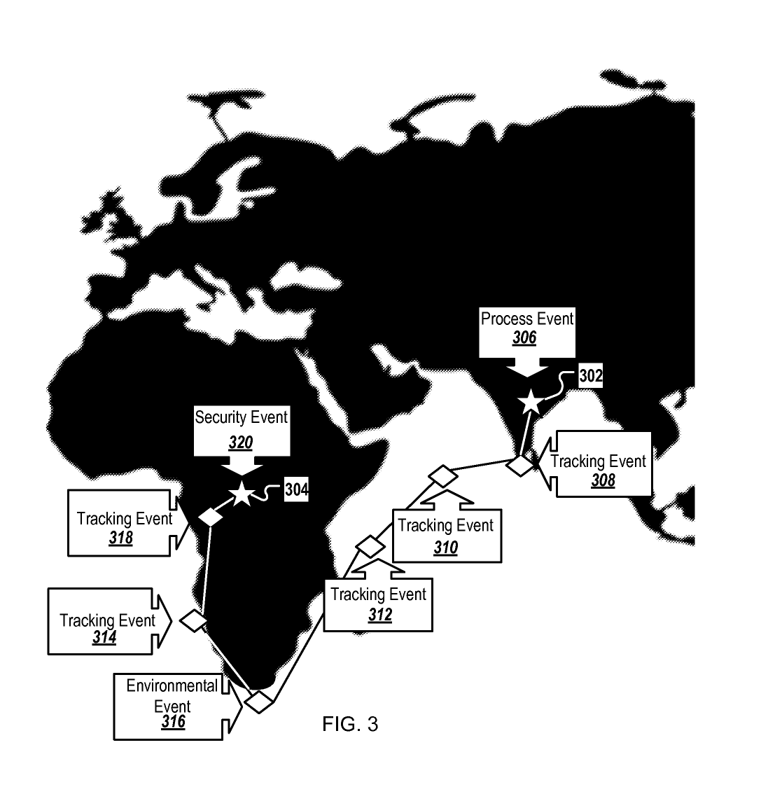

FIG. 3 illustrates an example journey of an asset from a origin location 302 to a destination location 304. As the asset travels from the origin location 302 to the destination location 304, a tag associated with the asset issues various event notifications. These event notifications are received and processed by an event server (e.g., event server 212).

When the tag is first coupled to the asset, the tag generates a process event notification 306 indicating that the tag is being commissioned (e.g., associated with the asset) and that the tag and the asset are beginning their journey. Process events generally occur at known locations, such as a warehouse from which the asset is being shipped. These locations can optionally be associated with geofences that define the boundaries of the locations.

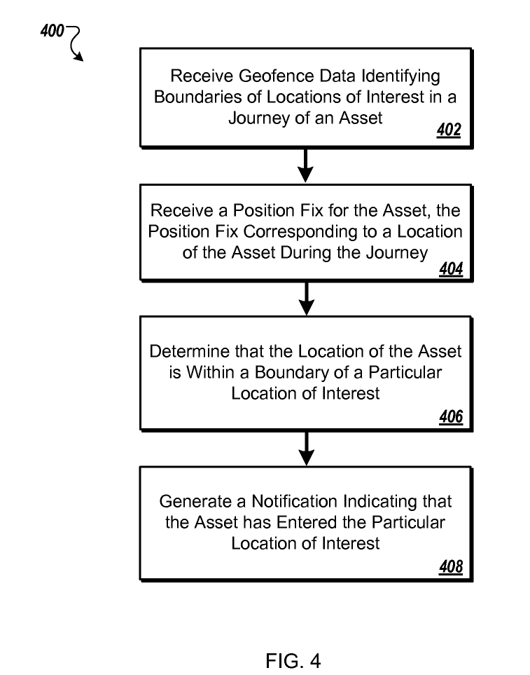

As the asset continues on its journey, the tag periodically generates tracking event notifications associated with tracking events (e.g., tracking events 308, 310, 312, 314, and 318). These event notifications provide updates on the current location of the asset, and can be used by the system to obtain useful information such as the path that the asset has traveled from its origin location, remaining distance or estimated time to the destination location, and the current location of the asset. Some of the tracking events (e.g., tracking events 308 and 318) can be used to determine that the asset has entered or left a port or other designated area (e.g., because the location is now inside or outside a geofence associated with the designated area, as described below with reference to FIG. 4).

In this specific example shipment route, as the asset rounds the Cape of Good Hope at the southern tip of Africa, the tag generates a notification for an environmental event 316. The environmental event 316 indicates that a particular environmental condition (e.g., temperature, humidity) has either exceeded or fallen below an acceptable range.

The asset eventually arrives at the destination location 304. The asset is opened before the tag is decommissioned, and the tag generates a notification for a security event 320 indicating that the asset has been opened or tampered with. In some implementations, when the system 200 receives the security event notification, the system 200 checks to see if the location of the security event 320 is inside a geofence corresponding to the destination location 302. If so, the system 200 can automatically determine that the asset's journey has ended. In other implementations, the tag can be decommissioned before it is opened, and the tag can generate a process event notification and send the notification to an event server (e.g., the event server 212) indicating the end of the journey instead of the security event.

Each event notification described above includes a position fix. The system 200 receives and processes each event notification and provides information to end user systems (e.g., using an information service like the information service 204). The information can include event notifications (e.g., identifying the type of event, the asset, the positional fix, and the date/time of the event). The information can also include additional information extracted from or associated with the event (e.g., a map of the route taken by the asset for a location event, or an association between an event and the contents of an asset associated with the event).

Some users may want more details than just the physical location of the asset, and a notification that an event has occurred. For example, users may want to know when assets are in particular locations (e.g., have entered particular geofences). Users may also want to know that potential problems may occur in the shipment of an asset if corrective action is not taken. Users may also want to know if certain actions need to be taken, as a result of a physical state of the asset (e.g., a location of the asset or environmental and security conditions of the asset) during shipment. Additional details of how this information can be generated and provided to users are described below.

### Example Process for Determining that an Asset has Entered or Left a Location of Interest

FIG. 4 is a flow diagram of an example process 400 for determining that an asset has entered or left a location of interest. For convenience, the process will be described in reference to a system that performs the process. The system can be, for example, a tag (e.g., tag 211), an event server (e.g., event server 212), or a system that includes a tag and an event server such as the tag system 200. The steps of process 400 need not occur sequentially or in the order described below.

The system receives geofence data indentifying boundaries of locations of interest in a journey of an asset (402). The geofence data can be, for example, latitude and longitude coordinates that define a boundary around the locations of interest. Other geographic coordinates according to other geographic coordinate systems can also be used. The locations of interest are important locations during the journey of the asset. The locations can include, but are not limited to, a warehouse of the enterprise shipping the asset, a warehouse of the enterprise receiving the asset, ports, terminals, railroad ramps, and other locations where an asset may be moved between conveyances, check points, and customs inspection points within ports and terminals. The system can receive the geofence data from databases that store geofence data for various public locations such as ports and terminals. The system can also receive the geofence data from the user tracking the asset. For example, a user can provide geofence data for the warehouses of his or her enterprise or the warehouses of other entities involved in shipment of the asset.

The system receives a position fix for the asset (404). The position fix corresponds to a location of the asset during the journey. The position fix can be, for example, a GPS or GPRS position fix. When the system is a tag, the position fix can be received, for example, from a GPS receiver on the tag. When the system is an event server, the position fix can be received, for example, as part of an event notification received from a tag associated with the asset. The events can include, but are not limited to, the events described above with reference to FIGS. 2 and 3.

The system determines that the location of the asset is within a boundary of a particular location of interest (406). The system determines that the location of the asset is within a boundary of a particular location of interest, for example, by determining whether the coordinates specified by the position fix are inside of the boundary associated with one of the locations of interest.

The system generates a notification indicating that the asset has entered the particular location of interest (408). The notification can be, for example, a tracking event notification indicating that the asset has entered the particular location of interest. The notification can be provided in a web interface or sent to the user via e-mail, text messaging, or other techniques.

In some implementations, the notification identifies the contents of the asset. The system determines the contents of the asset, for example, from data received from the user or another enterprise in the supply chain for the contents of the asset. This data can include, for example, purchase orders, invoices, purchase order changes, advance ship notices, shipping instructions, carrier bookings, bills of lading, commercial invoice, and other data associating the contents of the asset with the asset. The system analyzes the data to determine what items are currently being shipped in the asset.

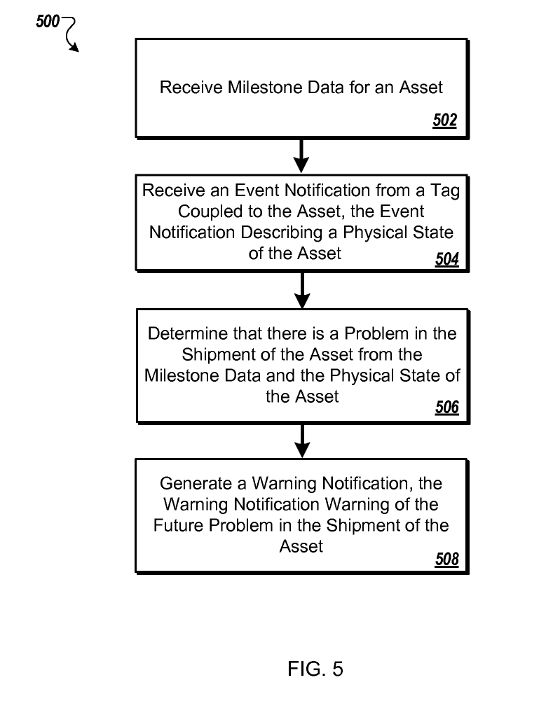

In some implementations, when the system determines that the asset has entered the particular location of interest, the system updates its internal databases. For example, the system can re-calculate the estimated time of arrival for the asset based on when the asset arrived at the particular location of interest. Recalculating the estimated time of arrival is described in more detail below with reference to FIG. 5. The system can also determine the time that the asset spent journeying between the last geofence and the particular location of interest and add that time to a database that stores the time assets spend on various segments of their journey.

In some implementations, the system receives another position fix for the asset at a later time. The other position fix corresponds to another location of the asset during the journey. The system determines that the second location of the asset is outside of the boundary of the particular location of interest, and then generates a notification indicating that the asset has left the particular location of interest. When the system determines that the asset has departed the geofence, the system can calculate the dwell time, e.g., how long the asset spent at the particular location. This information can be added to a database of information maintained by the system and used in later analysis, for example, as described below.

### Example Process for Determining that there is a Problem in the Shipment of the Asset

FIG. 5 is a flow diagram of an example process 500 for determining that a future problem in the shipment of the asset may occur if corrective action is not taken, and generating a warning notification identifying the future problem. For convenience, the process 500 will be described in reference to a system that performs the process. The system can be, for example, the tag system 200. The steps of process 500 need not occur sequentially or in the order described below.

The system receives milestone data for an asset (502). The milestone data identifies one or more milestones in a journey of the asset. Each milestone has an associated location. The milestone data can be, for example, an estimated schedule of the journey of the asset. The schedule can include estimated times that the asset should arrive at various locations along the journey. The milestone data can also be an enterprise policy for an enterprise tracking the asset. The enterprise policy can specify enterprise-specific deadlines that are relative to various events in the journey of the asset. For example, the enterprise policy can specify that an asset should be collected from its discharge location within ten hours of being released for pickup.

The milestone data can be received directly from a user (e.g., through a web portal), or can be received through an electronic data interchange (EDI) message gateway, e.g., the message server 218. Data received through the EDI message gateway can come from various sources including, for example, shipment messages, location status messages, customs messages, and messages from end users. Shipment messages can include, for example, purchase orders, purchase order changes, advance ship notices, shipping instructions, carrier bookings, bills of lading, and commercial invoices. These messages list one or more of the items in the asset, the buyer and seller of the items in the asset, and promised dates regarding delivery of the asset (ship-by date, deliver-by date, etc.). The messages can be used to identify milestones for delivery of assets, for example, a time by which an asset should arrive at its destination location. Location status messages can include, for example, truck carrier messages, ocean carrier messages, rail carrier messages, ocean vessel latitude and longitude messages (e.g., through either EDI 315 messages or GPS transponders). The customs messages are messages related to customs compliance, for example, import and export declaration forms, commercial invoices, hazardous material clearance documents, as well as EDI 350 related information describing what is being carried in the container as well as the customs status. End user messages are messages received from end users that provide, for example, details on the shipment of the asset, details of the contents of the asset, and enterprise milestone data.

The data received through the EDI message gateway can also include shipment context information for the assets, for example, an expected route that the asset will take, along with dates and times for key milestones in the journey of the asset. Shipment context information can also include EDI 315 messages, EDI 214 messages, EDI 350 messages, certificates of origin, export and import certificates, carrier invoices, bills of lading, booking information, data from non-intrusive inspection systems such as radiation portal monitors, and customs compliance data.

The system receives an event notification from a tag coupled to the asset (504). The event notification describes a physical state of the asset. The physical state of the asset can include a location of the asset and a time when the asset was at the location. The physical state can also identify a physical event in the journey of the asset, for example, that the asset has been sealed or that the asset has left a particular port. The system can additionally receive information from one or more sensors coupled to the tag, either as part of the event notification, or as part of a notification separate from the event notification. For example, the system can receive data from one or more accelerometers coupled to the tag. The accelerometer data can be used to identify signature patterns in the asset's movements, for example, that the asset is being loaded onto a vessel or that the asset is moving at a constant speed.

The system determines that there is a problem in the shipment of the asset from the milestone data and the physical state of the asset (506). The system can determine that a problem has already occurred, or that a future problem will occur if corrective action is not taken. The system can identify various problems that have already occurred, for example, that the asset was late leaving the origin location or that the asset missed sailing on a vessel. The system can identify various future problems in the shipment of the asset. For example, the system can determine that a particular milestone was not reached by a scheduled time, and therefore determine that if corrective action is not taken, subsequent milestones will also be missed. The system can also determine that if action is not taken within a threshold amount of time, a milestone will be missed. The threshold can be predetermined, or can be specified by the individual enterprises using the tracking service. For example, an enterprise can specify that it wants to be warned if it has less than ten hours to complete an action. The threshold can be different for the different future problems. The threshold can be zero, in which case, users are not notified until the system determines that a problem has occurred. The examples below describe example future problems that the system can detect. While many of the examples below describe detecting future problems when an asset is transported by a vessel, similar problems can be detected when the asset is transported by other conveyances.

### Late Arrival at Destination Location:

For example, users are normally concerned with whether an asset will arrive at its destination location on time. Therefore, when the milestone data includes a scheduled arrival time for the asset, the system can determine that an asset is late, or likely late, arriving at its destination. By warning a user that the asset arrived late, or is likely to arrive late, the system allows the user to take actions to accommodate for effects of the delay that will be felt by the buyer.

The system can use various heuristics to determine when an asset is late, or likely late, depending on what information is available to the system. For example, when the system receives an event notification indicating that the asset has arrived at the final destination, the system can compare the arrival time to the scheduled arrival time to determine if the asset was late arriving at the destination, e.g.:

late if: actual arrival time>scheduled arrival time. (1)

As another example, when the system receives the physical location of the asset from an event notification, the system can determine that the asset is likely late based on an estimated time of arrival from the asset, e.g.:

likely late if: estimated time of arrival>scheduled arrival time. (2)

The system determines the estimated time of arrival for the asset from the information included in an event notification received for the asset: specifically, a location of the asset and the time when the asset was at that location. In some implementations, the system calculates the estimated time of arrival from average travel duration for the remaining segments of the asset's journey (e.g., between a port near the current location of the asset and the destination location for the asset). The system can determine these average durations by analyzing historical data indicating the amount of time assets were travelling along a given segment. When there is only one route the asset can take, the system can calculate the estimated time of arrival by summing the average travel durations for the segments of the journey. When multiple routes are possible, the system can calculate the estimated length of the journey by calculating a route duration for each potential route by summing the average duration for each of the route segments, and then taking a weighted average of the route durations. The route durations can be weighted, for example, based on a likelihood that each route will be taken. The system can determine this likelihood by analyzing historical data on which routes assets have traveled. For example, the weights can be the number of journeys along a particular route between two locations, divided by the total number of journeys along any route between those two locations, or can just be the number of journeys along a particular route between the two locations.

As another example, when a user has specified that he or she wants to be warned a threshold amount of time before the asset is late, the system can determine whether the asset will be late if it does not arrive within the threshold amount of time. The system makes this determination by subtracting the threshold amount of time from the scheduled arrival time, and determining if the current time is after the result, e.g.:

likely late if: current time>scheduled arrival time−threshold. (3)

### Late Leaving Container Yard:

Users may also be interested in delays other than the final delay in arriving at the destination location. For example, an asset's journey begins when an empty asset is shipped from a container yard to the origin location where the asset will be loaded with contents and begin its journey. Users may be interested in knowing whether there was a delay in the empty asset leaving the container yard, and if so, whether that delay will affect later parts of the asset's journey. When the milestone data includes the estimated time when the loaded asset will depart from its origin location, the system can determine that an empty asset was delayed leaving the container yard and may not be loaded in time to depart the origin location on-time. Similarly, when the milestone data includes a vessel cut-off deadline, the system can determine that the asset may not arrive at the port-of-loading in time to be loaded onto a vessel. The vessel cut-off deadline is the latest that an asset can arrive at a port-of-loading and be loaded onto the vessel.

The system can determine whether a delay in the empty asset leaving the container yard will likely keep the asset from being loaded in time to depart the origin location on-time, depending on what information is available. When the system has received an event notification indicating that the empty container is beginning its journey to the origin location, the system can estimate how much time is needed for the empty asset to arrive at the origin location, and determine if there is sufficient time for the empty asset to arrive before the asset is scheduled to leave the origin location. To make this determination, the system calculates the average lead time between when an event notification indicating that an empty container is beginning its journey to the origin location is generated for an asset and when the asset actually leaves the container yard. The system also calculates the average lead time between when an asset leaves the container yard and arrives at the origin location, as well as the average dwell time at the origin location (e.g., how long assets remain at the origin location). These lead times can be calculated using historical data gathered from tracking other assets. The system then subtracts both average lead times from the estimated time when the loaded asset will depart its origin location. If the time the asset began its journey is after the result of the subtraction, then the asset is likely to not depart the origin location on time, e.g.:

late departing origin if: time of event notification>scheduled departure from container yard−average lead time to leave container yard−average lead time from container yard to origin location−dwell time at origin location. (4)

When a user has specified that he or she wants to be warned a threshold amount of time before the asset needs to leave the container yard in order to depart the origin location on time, and no event notifications indicating that the asset has begun its journey have been received, the system can determine that if the empty asset does not leave the container yard within the threshold amount of time, the asset is likely to leave the origin location late. To make this determination, the system subtracts the two average lead times and the dwell time described above, as well as the threshold amount of time, from the scheduled departure of the asset. If the current time is after to the result of this subtraction, then the asset is likely to miss the pickup window, e.g.:

likely late departing origin if: current time>scheduled departure from container yard−average lead time to leave container yard−average lead time from container yard to origin location−dwell time at origin−threshold. (4)

The system can similarly determine whether a delay in the empty asset leaving the container yard will likely keep the asset from arriving at the port-of-loading before the vessel cut-off deadline.

When the system has received an event notification indicating that the empty asset has begun its journey, the system determines whether the asset left the container yard in time to arrive at the origin location, be loaded with contents, and be sent to the port-of-loading before the vessel cut-off deadline. To make this determination, the system calculates the average lead time between when a notification indicating that the asset has begun its journey is generated and when the asset leaves the container yard. The system also calculates the average lead time between when an asset leaves the container yard and arrives at the origin location, as well as the average dwell time at the origin. The system also calculates the average lead time between when an asset arrives at the origin location and when the asset arrives at the port-of-loading. These lead times can be calculated using historical data gathered from tracking other assets. The system then subtracts the three average lead times from the vessel cut-off deadline. If the time the asset began its journey is after the result of the subtraction, then the asset is likely to not be loaded onto the vessel before the vessel cut-off deadline, e.g.:

will likely miss vessel cut-off if: time of event notification>vessel cut-off−average lead time to leave container yard−average lead time from container yard to origin location−average dwell time at origin−average lead time from origin location to port-of-loading. (5)

When a user has specified that he or she wants to be warned a threshold amount of time before the asset needs to leave the container yard in order to make the vessel cut-off deadline, and the system has not received an event notification indicating that the container has begun its journey, the system can determine that if the empty asset does not leave the container yard within a threshold amount of time, the asset is likely to not be loaded onto the vessel before the vessel cut-off deadline. To make this determination, the system subtracts the three average lead times and the average dwell time described above, as well as the threshold amount of time, from the vessel cut-off deadline. If the current time is after the result of this subtraction, then the asset is likely to not be loaded in time, e.g.:

will likely miss vessel cut-off if: current time>vessel cut-off−average lead time to leave container yard−average lead time from container yard to origin location−average dwell time at origin location−average lead time from origin location to port-of-loading−threshold. (6)

### Delay at Origin Location:

Users may also be interested in knowing whether there was a delay at the origin location for the asset, and if so, whether that delay will affect later parts of the asset's journey. For example, when the milestone data includes the vessel cut-off deadline, the system can determine that the asset is likely to miss the vessel cut-off deadline because there has been a delay in sealing an asset or a delay in the asset leaving the origin location. As another example, when the milestone data includes the ship-by date for the asset, the system can determine that there is a delay (or a likely delay) in the asset leaving the origin location, and therefore the asset is likely to miss the ship-by date.

An asset is sealed after the asset has been loaded. Sealing an asset indicates that the asset is ready to leave the origin location. When the system receives an event notification indicating that the asset has been sealed, the system can determine whether the asset was sealed in time to make the vessel cut-off deadline as follows. The system calculates the average lead time between when an event notification indicating the asset was sealed is received and when the asset leaves the origin. The system also calculates the average lead time between when the asset leaves the origin and when the asset arrives at the port-of-loading. These lead times can be calculated using historical data gathered from tracking other assets. The system then subtracts the two lead times from the vessel cut-off deadline. If the time of the event notification is after the result of the subtraction, then the system determines that the asset is likely to miss the vessel cut-off deadline, e.g.:

will likely miss vessel cut-off if: time of event notification>vessel cut-off−average lead time to leave origin−average lead time from origin location to port-of-loading. (7)

When a user has specified that he or she wants to be warned a threshold amount of time before the asset needs to be sealed in order to make the vessel cut-off deadline, and the system has not received an event notification indicating that the container has been sealed, the system can determine that if the asset is not sealed within the threshold amount of time, the asset is likely to not be loaded onto the vessel before the vessel cut-off deadline. To make this determination, the system subtracts the two average lead times described above, as well as the threshold amount of time, from the vessel cut-off deadline. If the current time is after the result of this subtraction, then the asset is likely to not be loaded in time, e.g.:

will likely miss vessel cut-off if: current time>vessel cut-off−average lead time to leave origin−average lead time from origin location to port-of-loading−threshold. (8)

The system can similarly determine that there has been a delay in the asset departing the origin location, and the asset is likely to miss the vessel cut-off deadline. When the system receives an event notification indicating that the asset has left the origin location, the system can determine whether the asset is likely to miss the vessel cut-off deadline as follows. The system calculates the average lead time between when the asset leaves the origin and arrives at the port-of-loading. This lead time can be calculated using historical data gathered from tracking other assets. The system then subtracts the lead time from the vessel cut-off deadline. If the time of the tracking notification is after the result of the subtraction, then the system determines that the asset is likely to miss the vessel cut-off deadline, e.g.:

will likely miss vessel cut-off if: time of event notification>vessel cut-off−average lead time from origin location to port-of-loading. (9)

When a user has specified that he or she wants to be warned a threshold amount of time before the asset needs to be sealed in order to make the vessel cut-off deadline, and the system determines that the asset has not left the origin location, the system can determine that if the asset does not leave the origin location within the threshold amount of time, the asset is likely to miss the vessel cut-off deadline. The system can determine that the asset has not left the origin location when the location of the asset is within the origin geofence, or when the system has not received any event notifications indicating that the asset has left the origin. To determine whether the asset will miss the vessel cut-off deadline, the system subtracts the average lead time described above, as well as the threshold amount of time, from the vessel cut-off deadline. If the current time is after the result of this subtraction, then the asset is likely to not be loaded in time, e.g.:

will likely miss vessel cut-off if: current time>vessel cut-off−average lead time from origin location to port-of-loading−threshold. (10)

The system can also determine whether the asset has (or will likely) depart the origin location after the required ship time. When the system receives an event notification indicating that the asset has left the origin location, the system can determine whether the time of the event notification is after the required ship time. If it is, then the asset left the origin location late, e.g.:

left origin location late if: time of event notification>scheduled ship time. (11)

When a user has specified that he or she wants to be warned a threshold amount of time before the asset needs to leave the origin location in order to make the required ship time, the system can determine that if the asset does not leave the origin location within the threshold amount of time, the asset will miss the required ship time. The system makes this determination by subtracting the threshold time from the required ship time. If the current time is after the result of this subtraction, the system determines that if the asset does not depart the origin location within a threshold amount of time, the asset will depart after the required ship time, e.g.:

likely late leaving origin if: current time>scheduled ship time−threshold. (12)

### Late Arrival at Port-of-Loading:

Users may be interested in knowing whether the asset arrived late at the port of loading, and if so, whether that delay will affect later parts of the asset's journey. For example, when the milestone data includes the vessel cut-off deadline, the system can determine that the asset is late (or likely late) arriving at the port of loading, and therefore, the asset may miss the vessel cut-off deadline.

For example, when the system receives an event notification indicating that the asset has arrived at the port-of-loading, the system can determine whether the asset arrived at the port by the vessel cut-off-deadline by comparing the time of the event notification to the vessel cut-off deadline, e.g.:

missed vessel cut-off if: time of event notification that asset has arrived at port-of-loading>vessel cut-off. (13)

When a user has specified that he or she wants to be warned a threshold amount of time before the asset needs to arrive at the port-of-loading in order to make the vessel cut-off deadline, and the system determines that the asset has not yet arrived at the port-of-loading, the system can determine that if the asset does not arrive at the port-of-loading within a threshold number of hours, then the asset will miss the vessel cut-off deadline. The system can determine that the asset has not yet arrived at the port of loading when the last event notification the system received for the asset had a location that was outside the geofence of the port-of-loading, or when the system has not received an event notification indicating that the asset has arrived at the port. The system can determine whether a warning should be issued by determining whether the current time is later than the vessel cut-off deadline minus the threshold amount of time. If so, the asset may miss the vessel cut-off deadline if it does not arrive at the port-of-loading within the threshold amount of time, e.g.:

will likely miss vessel cut-off if: current time>vessel cut-off−threshold. (14)

### Late Clearance of Customs:

Assets often need customs clearance before they can leave a country. If customs clearance is not received, then the assets cannot be loaded onto their corresponding vessels. Therefore, the system can monitor whether customs clearance will be received in time for an asset to be loaded onto a vessel. For example, when the milestone data includes the vessel cut-off deadline, the system can determine whether an asset is late (or likely late) in receiving customs export clearance, and therefore may not be loaded onto the vessel before the vessel cut-off deadline. The system can determine whether, and when, an asset has received customs clearance, for example, from EDI 350 messages received from customs or customs EDI 315 messages received from the carrier.

When the system receives a notification that the asset has been cleared by customs (e.g., from an event notification or a message from customs), the system can determine whether the asset was late in receiving customs export clearance by comparing the time the asset cleared customs to the vessel cut-off deadline. If the asset cleared customs after the vessel cut-off deadline, the system determines that the asset was not loaded onto the vessel before the vessel cut-off, e.g.:

missed vessel cut-off if: time that customs was cleared>vessel cut-off. (15)

When a user has specified that he or she wants to be warned a threshold amount of time before the asset needs to clear customs in order to make the vessel cut-off deadline, and the system has not received a notification that the asset has been cleared by customs, the system can determine that the asset is likely late clearing customs and that the asset is likely to miss the vessel cut-off if customs clearance is not secured within the threshold amount of time. The system does this by comparing the current time to the vessel cut-off deadline minus the threshold amount of time. If the current time is after the result of the subtraction, then the asset is likely to miss the vessel cut-off deadline if customs clearance is not secured within the threshold amount of time, e.g.:

will likely miss vessel cut-off if: current time>vessel cut-off−threshold. (16)

Late Loading of Asset onto Vessel:

Users may also be interested in knowing whether an asset was loaded onto a vessel in time to sail on the vessel. If the asset is not loaded onto the vessel in time, a user may have to make other arrangements for shipping the asset, otherwise, the asset will not arrive at its destination location.

For example, when the milestone data includes a scheduled vessel departure deadline and a number of hours in advance of departure by when the asset must be loaded onto the asset, the system can determine whether the asset is delayed (or likely delayed) being loaded onto the vessel, and whether the asset may miss the vessel departure deadline. The vessel departure deadline is a time at which the vessel is scheduled to depart a port (e.g., a port-of-loading, or a transship port where the asset is supposed to be transferred to another vessel). When the system determines that the asset has been loaded onto the vessel at a given time, the system makes this determination as follows. The system determines that the amount of time before the scheduled vessel departure deadline that the asset must be loaded onto the vessel, for example, from carrier policies. The system then subtracts that amount of time from the scheduled vessel departure deadline. If the resulting time is before the time the asset was loaded onto the vessel, the system determines that the asset was loaded onto the vessel late, and may miss the scheduled vessel departure, e.g.:

will likely miss scheduled vessel departure if: time of loading>vessel departure deadline−amount of time before departure that asset needs to be loaded onto vessel. (17)

The system can determine whether, and when, an asset was loaded onto the vessel in various ways. For example, the system can receive an event notification indicating that the asset has been loaded onto the vessel at a particular time. The system can receive sensor data for a particular time from sensors (e.g., an accelerometer) coupled to the tag associated with the asset, and match a signature of the sensors to a signature associated with an asset being loaded onto the vessel. The system can receive an event notification with a position fix for the asset at a particular time and determine that the position of the asset is within a threshold distance of the vessel (e.g., within the length of the vessel from the position of the vessel). The system can also receive carrier data indicating that the asset has been loaded onto the vessel at a particular time.

When a user has specified that he or she wants to be warned a threshold amount of time before the asset needs to be loaded onto the vessel in order to make the vessel departure deadline, and the system has not received a notification indicating that the asset has been loaded onto the vessel, the system determines whether the asset needs to be loaded onto the vessel within the threshold amount of time in order to make the vessel departure deadline. The system makes this determination by subtracting the number of hours in advance of departure by when the asset must be loaded onto the vessel and the threshold from the vessel departure deadline. If the current time is after the result of this subtraction, the system determines that if the asset is not loaded onto the vessel within the threshold amount of time, the asset is likely to miss the scheduled vessel departure, e.g.:

will likely miss scheduled vessel departure if: current time>vessel departure deadline−amount of time before departure that asset needs to be loaded onto vessel−threshold. (18)

Users may also be interested in whether an asset left a port on time. Example ports include the port of loading, a port along the journey of the asset, and a transship port where the asset is loaded onto another vessel. For example, when the milestone data includes the scheduled vessel departure deadline, the system can determine that the asset did not leave the port by the scheduled departure deadline, and therefore may not arrive at the destination location on time. The system can determine that the asset did not leave the port by the scheduled departure deadline by determining that the last event notification received for the asset indicated that the location of the asset was within the port, and that the time of the position fix is after the scheduled vessel departure deadline, e.g.:

missed scheduled departure if: time of position fix inside the port geofence>scheduled departure deadline. (19)

As another example, when the milestone data includes the actual time the vessel left the port, the system can determine that the asset was not loaded onto the vessel before the vessel left the port, and therefore the asset may not arrive at the destination location. The system can make this determination by determining that the position fix for the asset indicates that the asset is within the port and that the time of the position fix is after the actual time the vessel left the port, e.g.:

missed being on vessel if: time of position fix inside the port geofence>time vessel left port. (20)

As another example, when the milestone data includes the scheduled vessel departure deadline, the system can determine that the vessel did not depart by the scheduled vessel departure deadline, and thus the asset may be delayed. The system can make this determination in various ways. For example, when the event notification is a notification indicating that an asset has left the port, the system can compare the time of the event notification to the scheduled vessel departure deadline. If the time of the event notification is after the scheduled vessel departure deadline, then the system can determine that the vessel did not depart by the scheduled vessel departure deadline, e.g.:

missed scheduled departure if: time asset left port>scheduled departure deadline. (21)

The system can alternatively use other sources to determine the actual time the vessel left the port, for example, tracking data indicating a location of the vessel itself or messages from the carrier indicating the actual time the vessel left the port. If the asset has not generated an event notification indicating that it left the port, the system can alternatively use the current time, rather than the time the asset left the port, to determine that the asset will be leaving the port after the scheduled departure deadline.

### Late Arrival at a Port:

Users may also be interested in when an asset arrives at, or is close to, a port. Examples of ports include a transship port where the asset is scheduled to be transferred to another vessel or a discharge port where the asset is scheduled to be removed from a vessel. For example, when the milestone data includes the scheduled vessel arrival time at the port, the system can determine whether the asset has arrived late, or is likely to arrive late, at the port. The system can make this determination based on whether the asset is near the port, or has arrived at the port, on schedule.

When the system receives an event notification indicating that an asset is near port, e.g., within a predefined range of the port, the system can determine whether the asset is likely to arrive at the port late, given when the asset was near the port. The system can make this determination by determining the average lead time between when a tag generates an event notification indicating that it is near the port and when the asset actually arrives at the port. This lead time can be determined, for example, from an analysis of past data for assets being tracked. The system then subtracts this lead time from the scheduled vessel arrival date. If the time of the event notification is later than the time resulting from the subtraction, then the asset will likely be late arriving at the port, e.g.:

likely late at port if: time of event notification>scheduled arrival time−lead time from near port location to the port. (22)

The system can also determine that the asset will likely arrive late at the port by determining the average lead time from the previous port on the asset's journey to the current port the asset is arriving at. The system adds this determination to the time the asset left the previous port (e.g., from the time in an event notification indicating that the asset left the geofence of the previous port). If the scheduled departure time is before the result of the addition, the asset will likely be late arriving at the current port, e.g.:

likely late at port if: scheduled arrival time<time asset left previous port+average lead time from previous port to current port. (23)

When the system has not received an event notification indicating that the asset is near the port, the system can still determine that the asset will likely be late by comparing the result of the subtraction described above to the current time. If the current time is after the result of the subtraction, then the asset will likely be late arriving at the port, e.g.:

likely late at port if: current time>scheduled arrival time−lead time (24)

The system can also determine that the asset actually arrived late at the port. For example, when the system receives an event notification indicating that the asset has arrived at the port, the system can compare the time the asset arrived at the port to the scheduled arrival time. If the asset arrived after the scheduled arrival time, the system can determine that the asset arrived late, e.g.:

late at port if: time of event notification>scheduled arrival time (25)

The system can alternatively use other data to estimate the time the asset arrived at the port, for example, location data indicating a time when the vessel transporting the asset entered the geofence for the port or carrier messages indicating that the asset arrived at the port. The system can also determine that the asset will arrive late at the port if the system receives an event notification indicating that the asset has not yet arrived at the port, and the time of that event notification is after the scheduled arrival time.

### Late Obtaining Customs Clearance at a Destination Port:

Users may also be interested in knowing whether an asset obtained customs clearance at a destination port on time. For example, the milestone data can include an enterprise-specific number of hours from when an asset is unloaded from a vessel at a discharge port to when an asset obtains customs clearance. Alternatively or additionally, the milestone data can specify a free period, e.g., how long an asset can stay at the port once it is released by customs (or the carrier) without incurring fees. The free period can be port specific.

For example, when the milestone data includes an enterprise-specific number of hours from when an asset is unloaded from a vessel at a discharge port to when the asset obtains customs clearance, the system can determine whether the asset was late, or is likely late, in obtaining customs clearance. If the system determines that the asset has obtained customs clearance, the system compares the time the asset obtained customs clearance to the time the asset was unloaded from the vessel plus the enterprise-specific number of hours. If the time the asset obtained customs clearance is greater than the sum, the system determines that the asset was late obtaining customs clearance, e.g.:

late obtaining customs clearance if: time of customs clearance>time unloaded from vessel+enterprise policy time (26)

The system can determine when an asset was unloaded from the vessel, for example, from an event notification that indicates that the asset was unloaded from the vessel, or from EDI messages received from the carrier or the port indicating that the asset was unloaded. The system can also determine that an asset was unloaded from a vessel, for example, by matching a signature of sensor signals received from the asset to a signature in a predefined set of signatures that correspond to unload events. The system can also determine that an asset was unloaded from a vessel, for example, when the system receives event notifications for the asset, and the physical location in the event notifications is away from the vessel (e.g., more than a threshold distance from the vessel). The system can determine when the system obtained customs clearance, for example, from EDI messages received from customs or the carrier.

When a user has specified that he or she wants to be warned a threshold amount of time before the asset needs to clear customs in order to satisfy the enterprise policy, and the system has not received a notification that the asset has cleared customs, the system adds the enterprise policy time to the time the asset was unloaded from the vessel, subtracts the threshold amount of time, and then compares the current time to the result. If the current time is later than the result, the system determines that if the asset does not clear customs within the threshold amount of time, the policy will likely be violated, e.g.:

likely late obtaining customs clearance if: current time>time unloaded from vessel+enterprise policy time−threshold (27)

When the milestone data includes the length of a free period at the port, the system can determine that the asset did not receive customs clearance before expiration of the free period, or likely will not obtain customs clearance before the expiration of the free period. Users are often interested in monitoring whether the asset is going to clear customs before the free period, because large demurrage fees can be incurred if the asset stays at the port longer than the free period. If the system determines that the asset has obtained customs clearance, the system compares the time the asset obtained customs clearance to the time the asset was unloaded from the vessel plus the free period. If the time the asset obtained customs clearance is greater than the sum, the system determines that the asset was late obtaining customs clearance, e.g.:

late obtaining customs clearance if: time of customs clearance>time unloaded from vessel+free period (28)

When a user has specified that he or she wants to be warned a threshold amount of time before the asset needs to clear customs in order to be cleared before the free period expires, and the system has not received a notification that the asset has cleared customs, the system determines whether the asset needs to clear customs within the threshold amount of time in order to be cleared before the free period expires. To make this determination, the system adds the free period to the time the asset was unloaded from the vessel, subtracts the threshold amount of time, and then compares the current time to the result. If the current time is later than the result, the system determines that if the asset does not clear customs within the threshold amount of time, the asset will not clear customs before the expiration of the free period, e.g.:

likely late obtaining customs clearance if: current time>time unloaded from vessel+free period−threshold. (29)

Late Departure from Destination Port:

Users may also be interested in knowing whether an asset departed the destination port at a time in keeping with a schedule of the enterprise. For example, the milestone data can include enterprise policy data indicating a maximum number of allowable hours between when an asset is released by customs (or the carrier) at a destination port and when the asset leaves the port (e.g., goes gate out). Alternatively or additionally, the milestone data can specify a free period. Based on this milestone data, the system can determine whether the asset was late (or is likely late) in departing the port.

The system can determine when an asset left the destination port in various ways, for example, from an event notification indicating that the asset left the geofence of the port at a certain time or carrier messages indicating that the asset went gate-out at a certain time. The system can determine whether the asset left the destination port within the allowable time, by comparing the time the asset departed the port to the time the asset was released by customs (or the carrier). If the asset departed the port after the maximum allowable number of hours from when it was released from customs (or by the carrier), the system can determine that the asset did not go gate-out within the allowable time, e.g.:

late leaving port if: time asset left port>time of release+allowable hours. (30)

When a user has specified that he or she wants to be warned a threshold amount of time before the asset needs to depart the port in order to satisfy the enterprise policy, and the system has not received a notification that the asset has left the port, the system determines whether the asset needs to leave the port within the threshold amount of time in order to satisfy the enterprise policy. The system can make this determination by adding the maximum allowable hours to the time the asset was released by customs (or the carrier), and then subtracting the threshold amount of time. If the current time is after the result of these calculations, then the system can determine that the policy will be violated if the asset does not depart within the threshold amount of time, e.g.:

late leaving port if: current time>time of release+allowable hours+threshold. (31)

When the milestone data includes the length of a free period at the port, the system can determine that if the asset was late in departing the port, or that the asset is likely late in departing the port. Users may be particularly interested in tracking this problem, as the users can be subject to large demurrage fees at the ports if the asset does not depart the port before the expiration of the free period. When the system receives an event notification indicating that the asset has left the port at a certain time (or alternatively, a carrier message indicating that the asset left the port at the certain time), the system can determine whether the time the asset left the port is later than the time the asset was unloaded from the vessel plus the free period. If so, the asset was late leaving the port, e.g.:

late leaving port if: time asset left port>time asset was unloaded from vessel+free period. (32)

The system can determine when the asset was unloaded from the vessel, for example, as described above.

When a user has specified that he or she wants to be warned a threshold amount of time before the asset needs depart the port in order to not exceed the free period, and the system has not received a notification that the asset has left the port, the system determines whether the asset needs to leave the port within the threshold amount of time in order to leave before the free period expires. For example, the system can determine whether the current time is greater than the sum of the time the asset left the port and the length of the free period, minus the threshold amount of time. If so, the asset needs to leave the port within the threshold amount of time to avoid exceeding the free period, e.g.:

late leaving port if: current time>time asset was unloaded from vessel+free period−threshold. (33)

### Late Unsealing Asset at the Destination Location:

Users may also be interested in knowing whether an asset was unsealed at the destination location in keeping with a schedule of the enterprise. If the container is not unloaded and the empty container is not returned to the carrier, the enterprise can incur detention fees. For example, when the milestone data includes enterprise policy data indicating a maximum number of allowable hours from when an asset arrives at the destination location and when the asset is unsealed, the system can determine that there has been a delay (or is a likely delay) in unsealing the asset. The arrival time for the asset can be determined from an event notification indicating that the asset has arrived at the destination location.

The system can determine that the asset has been unsealed, for example, from an event notification indicating that the asset was unsealed. When the asset has been unsealed, the system can determine whether the time the asset was unsealed is after the time the asset arrived at the destination location plus the maximum number of allowable hours, e.g.:

not unsealed on time if: time of event notification that asset was unsealed>time of arrival+allowable hours. (34)

When a user has specified that he or she wants to be warned a threshold amount of time before the asset needs to be unsealed in order to satisfy the enterprise policy, and the system has not received a notification that the asset has been unsealed, the system can determine that if the asset is not unsealed within a threshold number of hours, the enterprise policy will be violated. The system can make this determination by adding the maximum number of allowable hours to the arrival time for the asset, and then subtracting the threshold. If the resulting time is before the current time, the system can determine that if the asset is not unsealed within the threshold, the enterprise policy will be violated, e.g.:

may not be unsealed on time if: current time>time of arrival+allowable hours−threshold. (35)

Once the system determines the problem, the system generates a warning notification (508). The warning notification warns of the problem in the shipment of the asset. The warning notification can be presented to a user, for example, in a web portal user interface or through e-mail or text messaging. In some implementations, the warning notification identifies the contents of the asset. The system can determine the contents of the asset, for example, as described above with reference to FIG. 4.

In some implementations, the system also dynamically determines a solution to the problem in the shipment and presents the solution to the user, for example, in the warning notification or in another notification. For example, the system can include an analysis engine that receives the milestone data described above, as well as data describing details of various routes from tags coupled to assets. The data describing the details of various routes can be real-time data describing the current status of the route (e.g., several assets in a given port have been sitting for longer than scheduled) or a compilation of data from previous routes (e.g., average travel time between ports, average travel time for particular carriers, etc.). The analysis engine analyzes this data to identify one or more solutions to the problem. For example, when the problem is that the asset was not loaded onto a vessel before the vessel departure date, the analysis engine can identify another vessel that is sailing from the same port from the milestone data and use the average travel time data to determine that the asset will reach the destination location in time if it travels on the other vessel. The system can then notify the user that if the other vessel is used, the problem will be solved. Similarly, if the problem is that an empty asset has not left the container yard in time to arrive at the origin location, be loaded with contents, and depart the origin location in time, the system can analyze milestone data identifying empty assets that are available and use the average travel time data to determine that an available empty asset can be shipped in time to reach the origin location in time. The system can then notify the user that if the alternative empty asset is sent, then the problem will be solved. Alternatively or additionally, the system can provide a centralized collaboration forum for various parties in the supply chain (carriers, logistic providers, enterprise users, etc.) to determine and execute a solution to the problem.

In some implementations, the system later determines that the problem in the shipment of the asset has either been solved, or never actually occurred. The system makes this determination when it receives a later event notification for the asset with updated information on the physical state of the asset. The system redoes the calculations described above based on the updated physical state of the asset, and determines that there is no longer a problem. The system can the notify the user that the problem has either been solved, or never actually occurred.

### Example Process for Determining that Dependent Processes should be Triggered

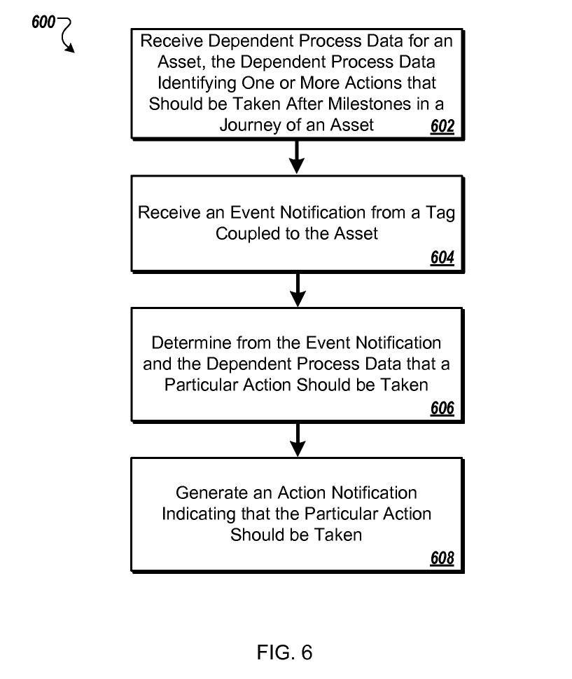

FIG. 6 is a flow diagram of an example process 600 for determining that a dependent process should be triggered. For convenience, the process 600 will be described in reference to a system that performs the process. The system can be, for example, the tag system 200. The steps of process 600 need not occur sequentially or in the order described below.

The system receives dependent process data for an asset (602). The dependent process data for the asset can be data for the asset itself, or data for items in the asset. The dependent process data identifies one or more actions that should be taken after events of interest in a journey of an asset. The events of interest are events that trigger the dependent processes, or events that provide data used by the dependent processes. The dependent process data can be received from individual enterprises that are tracking assets. For example, the individual enterprises can specify that an enterprise-specific action needs to be taken after a particular event of interest occurs. Examples of these actions include that particular trucks should be sent to pick up assets once the assets clear customs at the discharge port, or that shipment invoices should be generated upon delivery of the asset to its destination location.

The dependent processes can be managed by various supply chain management applications, including, but not limited to, order management systems, warehouse management systems, transportation management systems, supply chain planning systems, manufacturing execution systems, visibility systems, and supply chain exception management systems. Each of these systems is responsible for different dependent processes that are triggered by events that occur during shipment. For example, once an asset is filled with contents and sealed, the asset needs to be transported to where it will begin its journey. When an asset undergoes customs inspections during the journey, information needs to be provided to customs officials, and information received from customs officials needs to be processed. If environmental parameters are violated or security parameters are violated during shipment of the asset, then new cargo may need to be shipped in place of the cargo included in the asset. Once an asset is released for pickup at the discharge port, the asset needs to be picked up. When a vessel arrives near a discharge port, customs paperwork needs to be initiated. Once a tag is removed from the asset, the tag needs to be returned to the tag provider.

The system receives an event notification from a tag coupled to the asset (604). The event notification corresponds to an event in the journey of the asset. Example events include, but are not limited to, the events described above with reference to FIGS. 2 and 3. The event notification can describe a physical state of the asset. The physical state of the asset can include, but is not limited to, a physical location of the asset, a time at which the asset was at that physical location, an environmental state of the asset, and a security state of the asset.

The system determines from the event notification and the dependent process data that a particular action should be taken (606). The system processes the event notification to determine that an event of interest has occurred in the journey of the asset. For example, if the event notification is a process event indicating that a procedural event has occurred in the journey of the asset, the system can determine that the procedural event is an event of interest in the journey of the asset. As another example, if the event notification is a tracking event notification, the system can determine that the asset has entered or left a location of interest, for example, as described above with reference to FIG. 4. The system can then determine that entering or leaving the location of interest is an event of interest. As yet another example, if the event notification is an environmental event notification or a security event notification indicating that environmental parameters or security parameters for the journey of the asset have been violated, the system can determine that the violation is an event of interest. Once the system determines what event of interest (if any) has occurred, the system compares the event of interest to the dependent process data. If the dependent process data includes a particular action that should be taken when the event of interest occurs, the system selects the particular action. In some implementations, the system uses additional data about the shipment, e.g. EDI message data, to determine that an event of interest has occurred, or that a particular dependent process should be triggered. For example, the dependent process data can specify that certain dependent processes should be triggered only for assets containing particular products, and the system can use EDI message data to determine the contents of the asset.

The system generates an action notification indicating that the particular action should be taken (608). The action notification can be used to automatically trigger the desired action, either by instructing a supply chain management system, or other system associated with the enterprise tracking the asset or by directly instructing the party responsible for taking the desired action. For example, the action notification can instruct an enterprise system that an asset needs to be picked up from the discharge port. The system can be instructed through a system-to-system interface, for example, a Hypertext Transfer Protocol (HTTP), Secure Hypertext Transfer Protocol (HTTPS), or POST message, a web-service, or other similar interfaces. The system can also be instructed through various EDI messages, for example, EDI 214 or EDI 315 messages, or EDI surrogates based upon the EDI 214 or EDI 315 messages. These messages instruct the system that the desired action should be taken.

Alternatively, the action notification can be presented to a user, for example, in a web portal user interface or through e-mail or text messaging. When the action notification is presented to the user, the notification can include an identification of the contents of the asset. The contents can be determined, for example, as described above with reference to FIG. 4.

The combination of dependent process data and event notifications allows the system to help businesses run more efficiently than they can under conventional systems. For example, in conventional systems, workers are not scheduled to unload an asset until the asset arrives at the receiving dock. This can result in additional fees, such as driver wait time. In contrast, by using the dependent process data and the event notifications, the system can determine in advance that the asset is going to need to be unloaded, and therefore when workers should be scheduled to work. For example, the event notification can indicate that the asset is at a particular location. The system can determine that given the asset's location, the asset is likely to arrive at a receiving dock within a threshold amount of time (e.g., twenty-four hours). The system can then determine that a warehouse management system should schedule workers to be at the receiving dock to unload the asset. This allows the warehouse management system to have workers at the receiving dock when the asset arrives.

As another example, in conventional systems, transportation companies schedule a window for delivery for the asset well in advance. If the transportation company is unable to meet that window, they may face fees or other penalties. In contrast, by using the dependent process data and the event notifications, the transportation company can wait until it has determined that the asset is likely to arrive at a receiving dock within a threshold amount of time, and then schedule a window of time for delivery that is as close as possible to the estimated time of arrival.

As another example, in conventional systems, once an asset is cleared for discharge at a port of discharge, the carrier may put out a tender to identify a transportation company to transport the asset from the port of discharge to the destination location. The tender requests that the transportation companies provide a cost estimate for the transport. However, waiting until the asset is cleared for discharge can result in a delay in transporting the asset while the estimates are received and considered. In contrast, by using dependent process data and the event notifications, the system can determine in advance when the asset will likely be discharged, and start the tender process within a threshold amount of time before the estimated time of discharge.

As another example, in conventional systems, when an order management system receives an order, the system checks with a warehouse management system to determine if there is sufficient inventory to fill the order. If not, the order management system rejects the order. In contrast, by using the dependent process data and the event notifications, the system can determine that particular items are not currently in inventory, but will be in inventory within a specified lead time. Therefore, the warehouse management system can consider virtual inventory as well as actual inventory when deciding whether to fill the order. The system determines what inventory will arrive within a specified lead time according to event notifications indicating where assets containing the items of interest are. The system can consider the inventory to be physically in the warehouse, for example, by adding it to the physical inventory counts for the warehouse. For example, the system can consider all inventory that will arrive within a threshold amount of time to be physically in the warehouse. The system can alternatively or additionally consider the inventory to be in a different warehouse, for example, by associating the inventory with a “floating warehouse” that is considered to store all goods in transit. The “floating warehouse” can be a virtual warehouse created by the system. In some implementations, the system considers the inventory to be in the virtual warehouse until the estimated time of arrival for the asset is within a given threshold, at which point, it is added to the physical inventory counts for the actual warehouse.

As another example, in conventional systems, the supply chain management system uses the same lead time for all products or the same lead time for individual families of products. These lead times are estimates of the actual lead times for the individual products, and are often inaccurate. In contrast, by using event notifications, the system can track more accurate product-specific lead times based on event notifications indicating when assets containing particular products began and ended their journey. The system can then trigger a dependent process that provides the supply chain management system with up-to-date and product-specific lead times. For example, the system can update product-specific lead times as event notifications are received. The system can then trigger the dependent process to update the supply chain management system according to a schedule specified in the dependent process data (e.g., every quarter, every month, etc.). The system can alternatively or additionally trigger the dependent process, for example, each time the lead times are updated, or when the supply chain management system requests an update.

As yet another example, in conventional systems, when a new product is being produced on a manufacturing line, the manufacturing system waits until all of the inputs needed for the product are received before the manufacturing line is tooled up. In contrast, by using event notifications and dependent process data, the system can instruct the manufacturing system to begin tooling up in advance, so that the manufacturing line will be ready to start as soon as the last product arrives. For example, the dependent process data can indicate that the tooling up process should begin a certain amount of time before the inputs are received. The system can then process event notifications received for each asset containing part of the inputs, and determine when all of the inputs will arrive. The system can then notify the manufacturing system to begin tooling up the manufacturing line at the appropriate time based on when the assets are expected to arrive.

As yet another example, in conventional systems, it is difficult to do merges and splits in transit. A merge is when items from two different assets are combined, and a split is when items in a single asset are split into multiple assets. However, by using event notifications and dependent process data, the system can control merges and splits. For example, the system can control a merge of asset contents by determining from an event notification that a first asset to be merged has arrived at the port of discharge. The system then initiates a dependent process to hold the first asset at the port of discharge until the second asset to be merged arrives. When the system determines from an event notification that the second asset has arrived at the port of discharge, the system initiates a dependent process to merge the contents of the asset. The system can control a split of the contents of an asset, for example, by determining from an event notification that the asset has arrived at the port of discharge or another deconsolidation facility. The system can then initiate a dependent process that re-runs the delivery schedule to confirm that the contents should be split, and then initiates a dependent process to execute the split of the contents of the asset.

As another example, in conventional systems, the recipient of goods typically does not get an invoice requiring payment until he or she receives and inspects the goods. The recipient often takes time inspecting the goods, which delays the seller of the goods being able to issue the invoice. In contrast, by using the event notifications and dependent process data, the system can determine that the invoice should be sent at an earlier point in the process. For example, if previous event notifications indicate that the contents of the asset were verified when the asset was loaded, and no security breaches occurred during transit, the system can determine that the invoicing process should be started when the system receives an event notification indicating that the asset carrying the goods has arrived at its destination location.

As yet another example, in conventional systems, when goods in an asset are damaged in transit, the recipient of the asset identifies the damage. Before an insurance claim is initiated, fact finding as to when the goods were damaged and who had control of the asset at that time is required. Then, whoever is deemed to have been control of the asset at the time the contents were damaged must submit an insurance claim. In contrast, by using event notifications and dependent process data, the system can identify when an event occurred that likely resulted in damage to the goods, for example, from a security event notification. The system can then determine who was in custody of the goods at the time the security event notification occurred, and initiate a dependent process of filing an insurance claim on behalf of the party who had custody of the goods at the time the security event occurred.

The system can also use the dependent process data and event notifications to do things conventional systems do not do. For example, the system can receive an event notification indicating that an environmental exception occurred during shipment of an asset. The system can then determine whether the environmental exception was moderate or more than moderate, and then take appropriate action. For example, if the system determines that the exception was moderate, the system can initiate a dependent process to test the contents of the asset to determine if they are in acceptable condition. If the system determines that the environmental exception was more than moderate, the system can initiate a certified destruction process, or initiate a replacement shipment. The system can determine what is moderate and more than moderate, for example, from the dependent process data.

As another example, the system can determine when a shipment is going to be late arriving at its destination, as described above. The system can then initiate a dependent process to address the late shipment, for example, requesting the goods in the shipment from an alternative source.

As another example, the system can determine from the event notifications that an asset is about to enter a port in a given country or is about to be discharged from a vessel at a port in the given country (e.g., by comparing the location of the asset to a geofence of the port). The system can then initiate a dependent process that determines what duty is due. The system can optionally provide the dependent process with information such as the origin location, destination location, transaction value, and commercial invoice value of the transaction.

As yet another example, the system can determine from the event notifications that an asset is about to enter a port in a given country where the asset will go through customs (e.g., by comparing the location of the asset to a geofence of the port). The system can then initiate the submission of various customs forms to the government of that country. The system can also initiate a risk targeting process within the customs system maintained by the government of that country. For example, the system can provide the risk targeting process with information about the asset, such as where it was shipped to, where it was shipped from, and what is in the asset. The risk targeting process can then process that data and determine whether customs inspection is needed.

As another example, the system can determine that various milestones in the shipment of the asset have occurred (e.g., the asset shipped, the asset arrived at its destination country, the asset arrived at its destination location, the goods in the asset were approved, etc.). Depending on what milestone is reached, the system can then initiate particular financing transactions. For example, the system can instruct a buyer's system to provide payment to a bank, and a seller's system to request payment from the bank. The particular milestones and transactions that are initiated can be specified in the dependent process data.

The features described above can be implemented in digital electronic circuitry, or in computer hardware, firmware, software, or in combinations of them. The features can be implemented in a computer program product tangibly embodied in a computer readable medium, e.g., in a machine-readable storage device, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method, comprising:
receiving dependent process data for an asset, the dependent process data identifying one or more actions that should be taken after events of interest in a journey of the asset;
receiving an event notification from a tag coupled to the asset, the event notification describing a physical state of the asset;
determining, from the event notification that an event has occurred, and then determining, from the dependent process data that a particular action should be taken; and
generating an action notification, the action notification indicating that the particular action should be taken.

2. The method of claim 1, wherein the action notification instructs a system to take the particular action.

3. The method of claim 2, wherein instructing the system to take the particular action comprises instructing the system through a system-to-system interface.

4. The method of claim 2, wherein instructing the system to take the particular action comprises instructing the system using an electronic data interchange message.

5. The method of claim 2, wherein the system is chosen from the group consisting of: an order management system, a warehouse management system, a transportation management system, a supply chain planning system, a manufacturing execution system, a visibility system, and a supply chain exception management system.

6. The method of claim 1, wherein:
the event notification indicates that the asset has been discharged at a port of discharge; and
the particular action is scheduling a pickup of the asset at the port of discharge.

7. The method of claim 11, wherein:
determining that a particular action should be taken includes determining from the event notification that the asset will be discharged within a threshold amount of time; and
the particular action is initializing a process to select a transportation provider to pick up the asset.

8. The method of claim 1, wherein:
the event notification includes a location of the asset;
determining that a particular action should be taken includes determining from the location of the asset that the asset is expected to arrive at a destination location at a particular time; and
the particular action is scheduling workers to be at the destination location to unload the asset at the particular time.

9. The method of claim 1, wherein:
the event notification includes a location of the asset;
determining that a particular action should be taken includes determining form the location of the asset that the asset is expected to arrive at a destination location within a threshold amount of time; and
the particular action is scheduling a delivery window during which the asset will be delivered.

10. The method of claim 1, wherein:
the event notification includes a location of the asset;
determining that a particular action should be taken includes determining from the location of the asset that the asset will arrive at a destination location within a threshold lead time; and
the action notification indicates that a warehouse management system should update its virtual inventory to include the contents of the asset.

11. The method of claim 1, wherein:
the event notification includes a location of the asset;
determining that a particular action should be taken includes determining that the asset has arrived at a deconsolidation facility; and
the particular action is confirming that contents of the assets should be split, and then executing a split of the asset contents.

12. The method of claim 1, wherein:
the event notification indicates that an asset containing a particular item has arrived at a destination location;
determining that a particular action should be taken includes calculating an updated lead time for the particular item based on the event notification, and then determining that lead time data for the particular item should be updated; and
the action notification indicates that a supply chain management system should update a lead time for the particular item to be the updated lead time.

13. A system comprising:
a processor; and
a computer readable medium coupled to the processor and including instructions, which, when executed by the processor, causes the processor to perform operations comprising:
receiving dependent process data for an asset, the dependent process data identifying one or more actions that should be taken after events of interest in a journey of the asset;
receiving an event notification from a tag coupled to the asset, the event notification describing a physical state of the asset;
determining, from the event notification that an event notification has occurred, and then determining, from the dependent process data that a particular action should be taken; and
generating an action notification, the action notification indicating that the particular action should be taken.

14. The system of claim 13, wherein the instructions that cause generating the action notification include instructions that cause instructing a system to take the particular action.

15. The system of claim 14, wherein the instructions that cause instructing the system to take the particular action comprise instructions that cause instructing the system through a system-to-system interface.

16. The system of claim 14, wherein the instructions that cause instructing the system to take the particular action comprise instructions that cause instructing the system using an electronic data interchange message.

17. The system of claim 14, wherein the system is chosen from the group consisting of: an order management system, a warehouse management system, a transportation management system, a supply chain planning system, a manufacturing execution system, a visibility system, and a supply chain exception management system.

18. The system of claim 13, wherein:
the event notification indicates that the asset has been discharged at a port of discharge; and
the particular action is scheduling a pickup of the asset at the port of discharge.

19. The system of claim 131, wherein:
the instructions that cause determining that a particular action should be taken comprise instructions that cause determining from the event notification that the asset will be discharged within a threshold amount of time; and
the particular action is initializing a process to select a transportation provider to pick up the asset.

20. The system of claim 13, wherein:
the event notification includes a location of the asset;
the instructions that cause determining that a particular action should be taken comprise instructions that cause determining from the location of the asset that the asset is expected to arrive at a destination location at a particular time; and
the particular action is scheduling workers to be at the destination location to unload the asset at the particular time.

21. The system of claim 13, wherein:
the event notification includes a location of the asset;
the instructions that cause determining that a particular action should be taken comprise instructions that cause determining form the location of the asset that the asset is expected to arrive at a destination location within a threshold amount of time; and
the particular action is scheduling a delivery window during which the asset will be delivered.
